(19) United States
(12) Patent Application Publication
(10) Pub. No.: US 2026/0347569 A1
(43) Pub. Date: Nov. 5, 2026

(54) Polymer Composite With Low VOC Emission

(71) Applicants: Du Pont China Holding Company Limited, Shanghai Branch, Shanghai (CN); Celanese Polymers Holding, Inc., Wilmington, DE (US)

(72) Inventors: Carmen Covelli, Wilmington, DE (US); Jianying Chen, Pudong New District, Shanghai (CN)

(21) Appl. No.: 19/124,377

(22) PCT Filed: Oct. 26, 2022
(86) PCT No.: PCT/CN2022/127699

§ 371 Date: Apr. 25, 2025

(51) Int. Cl. C08K 3/32; C08J 3/20; C08K 3/016; C08K 5/00; C08K 7/14

(52) U.S. Cl. CPC C08K 3/32; C08J 3/203; C08K 3/016; C08K 5/005; C08K 7/14; C08J 2367/02; C08K 2003/324

(57) ABSTRACT

A thermoplastic composition includes at least one thermoplastic resin such as polybutylene terephthalate (PBT), polyethylene terephthalate (PET), a thermoplastic polyester elastomer (TPEE), or a combination of two or more of these; an additive that is a weak acid containing phosphorus elements such as a dihydrogen phosphate salt; and optionally an inorganic filler such as a reinforcing fiber. The thermoplastic composition exhibits decreased emission levels of VOCs such as tetrahydrofuran (THF) compared to the neat thermoplastic resins, especially upon heating, for example during melt processing.

### FIELD OF THE INVENTION

This invention relates to thermoplastic compositions with low VOC emission and good mechanical properties.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

Polybutylene terephthalate (PBT) is an engineering thermoplastic resin excellent in mechanical, chemical, electronic, and physical properties; and therefore, it has been used widely in various applications including automobile parts, consumer electronics, etc.

The oligomer in the PBT resin decomposes, however, to generate tetrahydrofuran (THF) gas when heated in a molten state, for example in processing steps such a molding or extrusion. The outgassing of THF may cause issues such as voids in molded parts, which negatively impacts their mechanical properties. PBT-containing resins are particularly prone to emit THF within the first weeks after molding. THF outgassing is accelerated when the resin or article experiences conditions of high temperature. In consumer applications such as electronics or automobile interiors, this outgassing will not be accepted by the consumers.

Moreover, a number of nations have enacted legislation that mandates strict emission limits for VOCs. For compliance with these national laws and regulations, the automobile industry has developed emission requirements that depend on the results of a number of test procedures. Therefore, automotive OEMs have initiated related specifications for low VOC emissions in vehicle interiors.

For at least these reasons, the development of low THF emission PBT is important consumer comfort and for consistency with principles of environmental health and safety.

Others have attempted to decrease the VOC emissions of polymer compositions. For example, U.S. Patent Appln. Publn. No. 2009/0039557 describes a method for production of low-emission molded articles from thermoplastic molding compositions comprising PBT, in which the mold comprises one or more vents for discharge of volatile content from the heated molding compositions.

U.S. Pat. No. 8,148,489, issued to Peacock et al., describes a method of reducing organic carbon emissions from PBT block-containing resins by adding a titanium-catalyst deactivating compound to the resin after polymerization.

European Patent No. 683201) describes a modified polybutylene terephthalate resin with a reduction in the amount of gas such as THF generated in high-temperature service. In this modification, a sulfonic acid compound is added to the PBT prior to the completion of the polycondensation.

Nevertheless, there remains a continuing need to reduce the VOC emission levels of polymeric materials, in particular when consumers would otherwise be exposed to harmful chemicals such as THF.

### SUMMARY OF THE INVENTION

Accordingly, provided herein is a polymer composition with low VOC emission levels, for example low THF emission levels. The polymer composition comprises a polymer and a weak acid containing phosphorus elements. Preferably, the polymer comprises PBT, and the weak acid comprises a dihydrogen phosphate salt.

Further provided is a method to reduce the VOC emission level of a polymer composition, in particular THF emissions of PBT compositions, by adding a weak acid containing phosphorus elements to the composition, preferably during melt processing, for example during a compounding process.

### BRIEF DESCRIPTION OF THE DRAWINGS

FIG. 1 is a graph of THF emission level vs. the concentration of weak acid in a polymer composition of the invention.

### DETAILED DESCRIPTION OF THE INVENTION

Described herein is a polymer composition with low THF emission levels. The composition comprises a polymer and a weak acid containing phosphorus elements, for example a dihydrogen phosphate salt. The polymer is preferably a PBT-containing polymer having esterified 1,4-butanediol end groups.

Without wishing to be held to theory, it is hypothesized that 1,4-butanediol is the product of hydrolytic de-esterification of a PBT-containing polymer to form a polymer having acid end groups. The 1,4-butanediol reacts further to form THF.

Still without wishing to be held to theory, it is further hypothesized that the weak acid protonates the hydroxyl group of the butanediol end group in the first step of a dehydration reaction to form a butenol end group.

The butenol end group, even if removed by de-esterification, will not react further to form THF. Moreover, as a non-volatile liquid, butenol does not affect the overall VOC emissions of the polymer composition.

Suitable polymers for use in the polymer composition include one or more polymers selected from the group consisting of Polyethylene terephthalates (PET); polybutylene terephthalate (PBT); copolyether ester elastomers having PBT or PBT segments; co-PBTs (i.e. PBTs in which some of the 1,4-butane diol is replaced with, for example, one or more other diols, such as aliphatic, cycloaliphatic (for example 1.4-cyclohexanedimethanol), or aromatic diols (for example 2.2-bis 4-(hydroxyethoxyphenyl)-propane, or in which the terephthalate group is replaced by the residue of other diacids such as isophthalic acid or adipic acid, and blends of any two or more of these.

Preferred polymers include one or more polymers selected from the group consisting of PBT, co-PBT, PET, PBT/PETalloy, and copolyether ester elastomers having PET or PBT segments

More preferred polymers include one or more polymers selected from the group consisting of PBT, co-PBT, and copolyether ester elastomers having PBT segments.

Polybutylene terephthalate (PBT) is a more preferred polymer. Suitable PBT polymers are described in U.S. Pat. No. 8,148,489, issued to Peacock et al.

Suitable PBT polymers are available commercially from DuPont Specialty Polymers USA, LLC, under the Crastin® trademark. Suitable PET polymers are available commercially from DuPont Specialty Polymers USA, LLC, under the Rynite® trademark.

Suitable thermoplastic copolyetheresters are described in Intl. Patent Appln. Publn. No. WO2021/257534 by Karayianni. In addition, suitable thermoplastic copolyetheresters are available under the trademark Hytrel® (DuPont Specialty Polymers USA, LLC, of Wilmington, DE) and under the tradenames Arnitel™ (available from DSM Engineering Materials of Evansville, IN) and Riteflex™ (available from the Celanese Corporation of Florence, KY, formerly Ticona)

The polymer composition may include from 26.1 to 99.9 wt % of the one or more polymers; preferably, 59 to 99.7 wt %; and more preferably 69.5 to 99.7 wt %. The weight percentages are based on the total weight of the polymer composition. Moreover, the weight percentages are complementary, that is, the sum of the weight percentages of the components of the polymer composition is 100 wt %.

The polymer composition further comprises one or more weak acids containing phosphorus elements. The suitable weak acids containing phosphorus elements have a structure such as below:

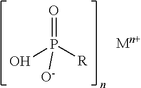

Wherein R is selected from H, OH, optionally substituted C₁₋₂₀ alkyl, optionally substituted C₂₋₂₀ alkylene, optionally substituted C₆₋₁₀ aryl, optionally substituted C₁₋₂₀ alkyloxy, polyoxy (C₂₋₄) alkylene, and optionally substituted C₆₋₂₀ aryloxy, and wherein M is selected from cations of H, Na, K, Ca, Mg, or Al, wherein n is the charge of the cation and the number of weak acid anions in the salt. When R is OH, however, then M is not H.

More preferred weak acids contain phosphate elements include, without limitation, dihydrogen phosphate salts and phenylphosphonic acid salts.

Suitable weak acids containing phosphate elements are available commercially from a number of sources, for example, the Sigma-Aldrich Corporation of Burlington, MA.

The polymer composition may include from 0.5 to 5 wt % of the one or more weak acids containing phosphate elements; preferably, 1 to 3 wt %; and more preferably 1.5 to 2 wt %. The weight percentages are based on the total weight of the polymer composition and are complementary with those of the other components of the polymer composition.

The polymer compositions disclosed herein may further comprise other additives, such as colorants, antioxidants, UV stabilizers, UV absorbers, heat stabilizers, lubricants, viscosity modifiers, nucleating agents, plasticizers, mold release agents, scratch and mar modifiers, impact modifiers, emulsifiers, optical brighteners, antistatic agents, acid adsorbents, smell adsorbents, anti-hydrolysis agents, anti-bacterial agents, density modifiers, reinforcing fillers, thermal conductive fillers, flame retardant fillers, glass fiber, electrical conductive fillers, coupling agents, end-capping reagents and combinations of two or more thereof. Based on the total weight of the polymer composition disclosed herein, such additional additive(s) may be present at a level of about 0.005-30 wt % or about 0.01-25 wt %, or about 0.02-20 wt %.

Examples of preferred optional additives include, without limitation, lubricants such as RADIA 7176, LOXIOL VPG861, LICOWAX OP and LICOLUB WE 40; antioxidants such as Irganox 1098 (CAS 23128-74-7), SONGNOX 1010, ANOX 20, and BENNOX 1010 G; stabilizers such as glycerol propoxylate; and flow modifiers such as LOXIOL P 861/3.5, LIONON DEH-40, VORANOL 2100 and PLASTHALL 809 etc.

Inorganic fillers are a preferred optional additive. When used, the inorganic fillers are preferably flame retardant fillers including, without limitation, aluminum hydroxide, magnesium hydroxide, red phosphorus, ammonium polyphosphate, zinc borate, antimony oxide and molybdenum compounds, and combinations of two or more flame-retardant fillers.

Glass fibers are a more preferred inorganic filler. The glass fibers preferably have a length of 4 to 30 mm and more preferably 4 to 7 mm. The glass fiber is preferred to be E-glass fiber (Alkali-free glass fiber), C-glass fiber (Medium alkali glass fiber), or A-glass fiber (High alkali glass fiber). E-glass fiber is more preferred.

The glass fibers are preferably coated by a coupling agent to increase their performance as reinforcing agents. The general structural formula of some preferred coupling agents is expressed as: R—Si(OR′)₃, where R is a functional group which will interact with the adhesive or matrix; R′ is usually methyl or ethyl, which, in use, is hydrolyzed to give a silanetriol: Si(OH)₃. Suitable coupling agents include, without limitation, KH-550, KH-560 and KH-570;
Suitable glass fibers are available commercially from TANSHAN FIBERGLASS CO, LTD, of Taian, Shandong, China.

The polymer composition may include from 5 to 50 wt % of the one or more optional inorganic fillers such as flame-retardant fillers and glass fibers; preferably, 15 to 45 wt %; and more preferably 20 to 40 wt %. The weight percentages are based on the total weight of the polymer composition and are complementary with those of the other components of the polymer composition.

The PBT used in this invention with different viscosity. The THF emission content at the same conditions is different based on different viscosity. The results show that the method is effective for PBT with different viscosity. The suitable viscosity is from 0.5 dl/gr to 1.5 dl/gr, the preferred viscosity is from 0.7 dl/gr to 1.2 dl/gr; the more preferred viscosity is from 0.8 dl/gr to 1.1 dl/gr.

The polymer composition may be produced by any conventional melt-blending method, such as for example in a twin-screw extruder.

Further provided herein are articles comprising the polymer composition. The suitable and preferred weak acids and other components of the polymer composition, suitable and preferred amounts of the weak acid and of the other components, and suitable and preferred methods for forming the polymer composition for use in the articles are as discussed above with respect to the polymer composition itself.

Examples of articles include, without limitation, Window lifter drive housing, Seat adjustment drive housing, Misc. switches and boxes, Steering angle sensor.

The articles may be formed by conventional methods, such as for example injection molding, blow molding, or extrusion methods. The more preferred forming method is injection molding.

Further provided is a method to decrease the THF emission of a polymer composition. The method comprises the steps of providing the other components of the polymer composition and of adding a weak acid containing phosphorus elements to the other components. The suitable and preferred weak acids containing phosphorus elements and other components of the polymer composition for use in this method, suitable and preferred amounts of the weak acid containing phosphorus elements and of the other components, and suitable and preferred processes for forming the polymer composition are as discussed above with respect to the polymer composition itself. Preferably, the weak acid containing phosphorus elements is added to the polymer composition during the compounding process.

The VOC emissions of the polymer composition and of the article may be further reduced by collecting the VOCs, such as THF, by applying a vacuum to the molten polymer during the compounding or molding process.

The following examples are provided to describe the invention in further detail. These examples, which set forth a preferred mode presently contemplated for carrying out the invention, are intended to illustrate and not to limit the invention.

### Examples of the Invention

### 1) Molding Conditions

The examples and comparative examples are molded into 60×60×2 mm and 60×60×1 mm plates under the following conditions:
Melt temperature: 250 °C, 280 °C
Mold temperature: 80 °C
Hold up time: 5 min

### 2) Gas Emission Test

The extent of the emission of volatile organic substances from the tested polymer compositions was determined by the method set forth in the Verband der Automobilindustrie [The German Association of the Automotive Industry (VDA)] standard VDA 277. In particular, it refers to the emission of THF, which generally occurs immediately after molding, extruding, or shaping a polymer composition. THF emission from PBT can be measured using gas chromatography (GC), for example gas chromatography-mass spectrometry (GC-MS)

After the plates were molded, they were stored in a sealed aluminum foil bag. To conduct the analysis, the plates were removed from the bag and cut into small pieces, then tested by GC/MS following the VDA277 standard. In this method, the GC/MS settings are:
Stove temperature program GC: 3 minutes isotherm at 50 °C
Heating at 200 °C with a rate of 12 K/min
4 minutes isotherm at 200 °C
Injector temperature: 200 °C
Detector temperature: 250 °C
Split ratio: approx. 1:20
Carrier gas: helium
Middle carrier gas speed: approx. 22-27 cm/s.

Calibration: 2,6-Di-tert-butyl-4-methylphenol (BHT) must exhibit a retention time of less than 16 minutes when run under the same conditions as the emissions from the polymer compositions.

The THF emission of compositions including three PBT polymers having different viscosities (i.e., different molecular weights) was measured.

### 3) IV (Intrinsic Viscosity) of PBT was Determined According to ASTM D2857

### 4) Materials

PBT-1: polybutylene terephthalate having an IV of 0.7 dl/gr was obtained from CHANG CHUN PLASTICS CO. LTD
PBT-2: polybutylene terephthalate having an IV of 0.9 dl/gr was obtained from CHANG CHUN PLASTICS CO. LTD
PBT-3: polybutylene terephthalate having an IV of 1.0 dl/gr was obtained from CHANG CHUN PLASTICS CO. LTD
NaH₂PHO₄: powder was obtained from NAGASE&CO., LTD
Glass fiber: was obtained from TANSHAN FIBERGLASS CO, LTD. Grade name is S-1HM436S

In each of the comparative examples CE1-CE6 and examples E1-E12, a polymer composition (weight percentages of non-PBT components are listed in Table 1) was prepared by compounding in an extruder. The barrel temperatures were set at about 250 °C and screw speed at about 350 rpm. After exiting the extruder, the blended compositions were cooled by water and cut into resin pellets, which was followed by drying for about 15 h at a temperature of 90 °C in an electric blast dyer.

The dried resin pellets obtained in comparative examples CE1-CE4 and examples E1-E8 were injection molded into 60×60×2 mm plaques with the melt temperature of 250 °C; comparative example CE5 and examples E9-E10 were injection molded into 60×60×1 mm plaques with the melt temperature of 280 °C; comparative example CE6 and examples E11-E12 were injection molded into 60×60×2 mm plaques with the melt temperature of 280 °C. The emission performance of the plaques was measured and is tabulated in Table 1, Table 2, and Table 3. In these Tables, the term “Balance” means the difference between 100 wt % and the sum of the weight percentages of the other components of the examples and comparative examples.

Further, for each sample, the tensile stress and tensile strain at break were measured in accordance with ISO 527-2:2012; the flexure stress was measured in accordance with ISO 178; and the N-charpy impact was measured in accordance with ISO 179-1. Results are tabulated in Table 1.

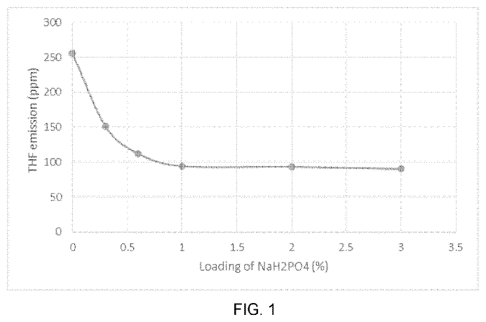

The test results of different loading of NaH₂PO₄ are list in Table 1 (E1, E5-E8). The graph of FIG. 1 shows that the optimized range of loading is greater than 0.3 wt %, greater than 0.5 wt %, or about 3 wt %.

TABLE 1

| | CE1 | E1 | E5 | E6 | E7 | E8 | CE2 | E2 | CE3 | E3 | CE4 | E4 |
|---|---|---|---|---|---|---|---|---|---|---|---|---|
| PBT-1 | — | Bal- | Bal- | Bal- | Bal- | Bal- | | | | | | |
| | | ance | ance | ance | ance | ance | | | | | | |
| PBT -2 | | | | | | | Bal- | Bal- | | | | |
| | | | | | | | ance | ance | | | | |
| PBT-3 | | | | | | | | | Bal- | Bal- | Bal- | Bal- |
| | | | | | | | | | ance | ance | ance | ance |
| Glass fiber | | | | | | | | | | | 30 | 30 |
| NaH2PO4 | | 0.3 | 0.6 | 1 | 2 | 3 | | 0.3 | | 0.3 | | 0.3 |
| Emission of THF | 255 | 151 | 112 | 94 | 93 | 90 | 334 | 161 | 210 | 77 | 78 | 22 |
| (ppm) | | | | | | | | | | | | |
| Tensile Stress | 50 | 52 | 53 | 52 | 50 | 42 | 50 | 51 | 48 | 46 | 132 | 134 |
| (MPa) | | | | | | | | | | | | |
| Flexure stress | 87 | 85 | 89 | 89 | 91 | 87 | 87 | 85 | 84 | 84 | 189 | 197 |
| (MPa) | | | | | | | | | | | | |
| N-charpy impact | 1.7 | 1.6 | 1.7 | 1.7 | 1.6 | 1.6 | 3.5 | 3.7 | 3.2 | 3.1 | 8.2 | 8.8 |
| (KJ/m2) | | | | | | | | | | | | |

TABLE 2

| | CE5 | E9 | E10 |
|---|---|---|---|
| PBT-3 | Balance | Balance | Balance |
| Glass fiber | 30 | 30 | 30 |
| KH2PO4 | 0 | 0 | 0.3 |
| NaH2PO4 | 0 | 0.3 | 0 |
| Emission of THF (ppm) | 208 | 94 | 93 |

TABLE 3

| | CE6 | E11 | E12 |
|---|---|---|---|
| PBT-3 | Balance | Balance | Balance |
| Glass fiber | 30 | 30 | 30 |
| C6H7PO3 | 0 | 0.3 | 0 |
| NaH2PO4 | 0 | 0 | 0.3 |
| Emission of THF (ppm) | 124 | 77 | 72 |

While certain of the preferred embodiments of this invention have been described and specifically exemplified above, it is not intended that the invention be limited to such embodiments. Various modifications may be made without departing from the scope and spirit of the invention, as set forth in the following claims.

1. A thermoplastic composition comprising:
a) at least one thermoplastic resin selected from the group consisting of polybutylene terephthalate (PBT), polyethylene terephthalate (PET), and a polymer which contains a copolymerized PBT component;
b) a weak acid containing phosphorus elements having the structure: 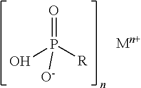
wherein R is selected from the group consisting of H, OH, optionally substituted C₁₋₂₀ alkyl, optionally substituted C₂₋₂₀ alkylene, optionally substituted C₆₋₁₀ aryl, optionally substituted C₁₋₂₀ alkyloxy, polyoxy (C₂₋₄) alkylene, and optionally substituted C₆₋₂₀ aryloxy;
wherein M is selected from the group consisting of cations of H, Na, K, Ca, Mg, Al;
wherein n is the charge of the cation of M; and
with the proviso that when R is OH, M is not H; and
c) other additives

2. The thermoplastic composition according to claim 1, wherein the at least one thermoplastic resin comprises PBT.

3. The thermoplastic composition according to claim 1, wherein the at least one thermoplastic resin comprises a thermoplastic copolyetherester having a copolymerized PBT component.

4. The thermoplastic composition according to claim 1, wherein the at least one thermoplastic resin is present in an amount of from 10 wt % to 99.9 wt %, based on the total weight of the thermoplastic composition.

5. The thermoplastic composition according to claim 1, wherein the weak acid comprises dihydrogen phosphate salts or phenylphosphonic acid salts.

6. The thermoplastic composition according to claim 1, wherein the weak acid comprises sodium dihydrogen phosphate, potassium dihydrogen phosphate, or both sodium dihydrogen phosphate and potassium dihydrogen phosphate.

7. The thermoplastic composition according to claim 1, wherein the weak acid is present in an amount of from 0.01 to about 3 wt %, based on the total weight of the thermoplastic composition.

8. The thermoplastic composition according to claim 1, wherein the weak acid is present in an amount of from 0.01 to about 2 wt %, based on the total weight of the thermoplastic composition.

9. The thermoplastic composition according to claim 1, wherein the weak acid is present in an amount of from 0.01 to about 1 wt %, based on the total weight of the thermoplastic composition.

10. The thermoplastic composition according to claim 1, wherein the at least one inorganic filler comprises a flame-retardant filler.

11. The thermoplastic composition according to claim 1, wherein the flame-retardant filler comprises one or more fillers selected from the group consisting of aluminum hydroxide, magnesium hydroxide, red phosphorus, ammonium polyphosphate, zinc borate, antimony oxide and molybdenum compounds.

12. The thermoplastic composition according to claim 1, wherein the optional inorganic filler is a reinforcing filler.

13. The thermoplastic composition according to claim 13, wherein the reinforcing filler is selected from the group consisting of glass fibers, silica, talc, mica, carbon black, carbon fiber, aramid fiber, hollow glass spheres, glass flake, hollow glass beads, milled glass fiber, and combinations of two or more thereof.

14. The thermoplastic composition according to claim 1, wherein the optional inorganic filler is present in an amount of from 0.01 to about 50 wt %, based on the total weight of the thermoplastic composition.

15. The thermoplastic composition according to claim 1, further comprising one or more other additives selected from the group consisting of lubricants; plasticizers; colorants; and antioxidants.

16. A method of reducing the VOC emissions of a polymer composition, comprising the steps of:
a) providing a polymer composition, said polymer composition comprising at least one thermoplastic resin selected from the group consisting of polybutylene terephthalate (PBT), polyethylene terephthalate (PET), and a polymer which contains a copolymerized PBT component; and optionally an inorganic filler; and
b) adding a weak acid containing phosphorus elements to the polymer composition.

17. The method of claim 16, further comprising the steps of:
c) melting the polymer composition; and
d) collecting the VOCs emitted by the molten polymer composition by applying a vacuum.
